(19) United States
(12) Patent Application Publication
(10) Pub. No.: US 2023/0201830 A1
(43) Pub. Date: Jun. 29, 2023

(54) CONTROLLING MICROFLUIDIC MOVEMENT VIA AIRBORNE CHARGES

(71) Applicant: Hewlett-Packard Development Company, L.P., Spring, TX (US)

(72) Inventors: Omer Gila, Palo Alto, CA (US); Napoleon J. Leoni, Palo Alto, CA (US); Viktor Shkolnikov, Palo Alto, CA (US); Keith E. Moore, Palo Alto, CA (US)

(73) Assignee: Hewlett-Packard Development Company, L.P., Spring, TX (US)

(21) Appl. No.: 17/928,275

(22) PCT Filed: May 29, 2020
(86) PCT No.: PCT/US2020/035369

§ 371 Date: Nov. 28, 2022

(51) Int. Cl. B01L 3/00; G01N 27/447

(52) U.S. Cl. CPC B01L 3/502761; G01N 27/44791; B01L 2400/0427; B01L 2300/0645; B01L 2300/0832; B01L 2300/16; B01L 2200/0647

(57) ABSTRACT

A microfluidic device includes a support and a non-contact charge depositing unit to selectively emit airborne charges of a selectable polarity. The support is to releasably support a consumable microfluidic receptacle in spaced relation to the charge depositing unit to receive the airborne charges on a portion of the consumable microfluidic receptacle to cause an electric field within the consumable microfluidic receptacle to control electrowetting movement of a liquid droplet within the consumable microfluidic receptacle.

### BACKGROUND

Microfluidic devices are revolutionizing testing in the healthcare industry. Some microfluidic devices comprise digital microfluidic technology, which may employ circuitry to move fluids.

### BRIEF DESCRIPTION OF THE DRAWINGS

FIG. 1 is a diagram including a side view schematically representing an example device and/or example method of controlling electrowetting movement via airborne charges.

FIG. 2 is a diagram including a top view schematically representing an example consumable microfluidic receptacle.

FIG. 3A is a diagram including a side view schematically representing an example consumable microfluidic receptacle including a coating to facilitate electrowetting movement.

FIG. 3B is a diagram including a side view schematically representing an example consumable microfluidic receptacle including an anisotropic conductivity layer.

FIG. 4 is an isometric view schematically representing an example addressable airborne charge depositing unit including a needle within a cylinder.

FIG. 5A is a diagram including a side view schematically representing an example addressable airborne charge depositing unit, including a charge building element and a charge neutralizing element.

FIG. 5B is a diagram including an isometric view schematically representing an example addressable airborne charge depositing unit, including a charge building element and a pair of charge neutralizing elements.

FIG. 6 is a diagram including a side view schematically representing an example two-dimensional addressable charge depositing unit in charging relation to a portion of a consumable microfluidic receptacle.

FIG. 7 is diagram including a sectional end view schematically representing an example addressable airborne charge depositing unit, including a corona wire and array of individually controllable electrode nozzles.

FIG. 8 is a diagram including a top view schematically representing an example array of individually controllable electrode nozzles of an example addressable airborne charge depositing unit.

FIGS. 9 and 10 are each a diagram including a series of side views schematically representing an example device and/or example method of microfluidic operation via electrowetting movement from deposited airborne charges.

FIG. 11A is a block diagram schematically representing an example fluid operations engine.

FIG. 11B is a block diagram schematically representing an example control portion.

FIG. 11C is a block diagram schematically representing an example user interface.

FIG. 12 is a flow diagram schematically representing an example method of depositing airborne charges to cause electrowetting movement of droplets.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure are directed to providing a consumable microfluidic receptacle by which digital microfluidic operations can be performed in an inexpensive manner. In some examples, an addressable airborne charge depositing unit may be brought into spaced apart, charging relation to a plate (e.g. a second plate) of the consumable microfluidic receptacle, whereby the charge depositing unit is to emit airborne charges to cause an electric field through the plate which induces electrowetting movement of a droplet within and through the microfluidic receptacle. In one aspect, “charges” as used herein refers to ions (+/−) or free electrons. In some examples, the addressable airborne charge depositing unit may sometimes be referred to as a non-contact charge depositing unit, as a non-contact charge head, and the like. In some examples, the plate may sometimes be referred to as a sheet, a wall, a portion, and the like. Moreover, it will be apparent that in some examples, the consumable microfluidic receptacle may form part of and/or comprise a microfluidic device. In some examples, the consumable microfluidic receptacle may sometimes be referred to as a single use microfluidic receptacle, or as being a disposable microfluidic receptacle.

In some examples, each droplet comprises a small, single generally spherical mass of fluid, such as may be dropped into the consumable microfluidic receptacle. As described above, the entire droplet is sized to be movable via electrowetting forces. In sharp contrast, dielectrophoresis may cause movement of particles within a fluid, rather than movement of an entire droplet of fluid. Some further example details are provided below.

In some examples, the addressable airborne charge depositing unit may emit the airborne charges having a first polarity and/or an opposite second polarity, depending on whether the charge depositing unit is to build charges on the plate or is to neutralize charges on the plate. The first polarity may be positive or negative depending on the particular goals, while the second polarity will be the opposite of the first polarity.

In some examples, the movement of droplets (caused by electrowetting forces) may occur between adjacent target positions along passageways within a microfluidic receptacle of a microfluidic device, with the target positions corresponding to locations at which the airborne charges are directed from the example non-contact, addressable charge depositing unit.

Via such example arrangements, the consumable microfluidic receptacle (of a microfluidic device) may omit control electrodes which would otherwise be used to cause microfluidic operations such as moving, merging, and/or splitting droplets within a microfluidic device. Moreover, by providing the non-contact addressable charge depositing unit to cause an electric field on a portion of the consumable microfluidic receptacle, the consumable microfluidic receptacle may omit inclusion of a printed circuit board and circuitry typically associated with digital microfluidic devices. This arrangement may significantly reduce the cost of the consumable microfluidic receptacle of the microfluidic device and/or significantly ease its recyclability.

Moreover, because the consumable microfluidic receptacle omits such control electrodes (for causing electrowetting movement) and omits complex circuitry which is typically directly connected to the control electrodes via conductive traces, the example consumable microfluidic receptacle of the present disclosure is not limited by the limited space constraints typically arising from a one-to-one correspondence between control electrodes and the complex control circuitry. Absent such space constraints, a greater number of target positions along the passageways of the microfluidic receptacle may be used, which may increase the precision by which microfluidic operations are performed, with a resolution (e.g. number of target positions for a given area) of such target positions corresponding to the capabilities (e.g. resolution) that the non-contact addressable charge depositing unit can deposit charges. By being able to re-use the non-contact, addressable charge depositing unit over-and-over again with a supply of disposable or consumable microfluidic receptacles, this example arrangement greatly reduces the overall, long term cost of using digital microfluidic devices while significantly conserving valuable electrically conductive materials.

In some examples, the consumable microfluidic receptacle may be used to perform microfluidic operations to implement a lateral flow assay and therefore may sometimes be referred to as a lateral flow device. In some examples, the consumable microfluidic receptacle also may be used for other types of devices, tests, assays which rely on or include digital microfluidic operations, such as moving, merging, splitting, etc. of droplets within internal passages within the microfluidic device.

In at least some examples, when the plate (e.g. a second plate) is not conductive, at least some example non-contact, addressable charge depositing units of the present disclosure stand in sharp contrast to some digital microfluidic devices which include an on-board, array of control electrodes (connected to a power supply) which operate at a constant voltage and which are constantly changing the number of charges in the electrodes to maintain a desired voltage while the droplet is pulled into the induced electric field. However, via at least some example non-contact, addressable charge depositing units of the present disclosure, charges are deposited on an exterior portion of a second plate of a consumable microfluidic receptacle such that a generally constant amount of charges may be maintained while a voltage at this second plate changes when a liquid droplet propagates into an induced, electric field zone and, at the same time, changes its intensity.

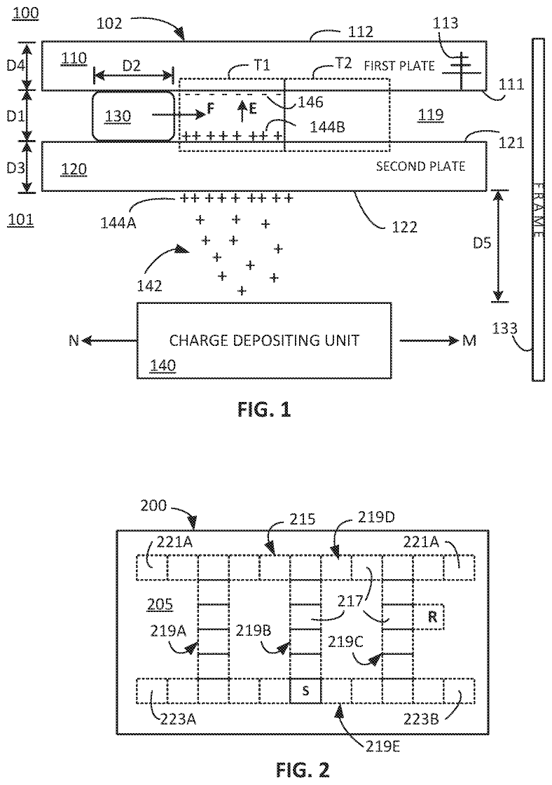

These examples, and additional examples, are further described and illustrated below in association with at least FIGS. 1-12.

FIG. 1 is a diagram 100 including a side view schematically representing an example arrangement 101 (and/or example method) to control electrowetting movement via airborne charges. In some examples, the arrangement 101 may comprise a consumable microfluidic receptacle 102 and a non-contact charge depositing unit 140, either of which may be provided separately. As shown in FIG. 1, the consumable microfluidic receptacle 102 comprises a first plate 110 and a second plate 120 spaced apart from the first plate 110, with the spacing between the respective plates 110, 120 sized to receive and allow movement of a liquid droplet 130. In some examples, the consumable microfluidic receptacle may form a portion of a microfluidic device, and according sometimes may be referred to as a microfluidic device or portion thereof.

As shown in FIG. 1, in some examples each of the respective first and second plates 110 comprise an interior surface 111, 121, respectively, and each of the respective first and second plates 110, 120 comprise an exterior surface 112, 122, respectively.

In some examples, at least the interior surface 111, 121 of the respective plates 110, 120 may comprise a planar or substantially planar surface. However, it will be understood that the passageway 119 defined between the respective first and second plates 110, 120 may comprise side walls, which are omitted for illustrative simplicity. The passageway 119 may sometimes be referred to as a conduit, cavity, and the like.

It will be understood that the first and second plates 110, 120 may form part of, and/or be housed within a frame, such as the frame 205 of the microfluidic device 200 shown in FIG. 2.

In some examples, the interior of the passageway 119 (between plates 110, 120) may comprise a filler such as a dielectric oil, while in some examples, the filler may comprise air. In some such examples, the filler may comprise other liquids which are immiscible and/or which are electrically passive relative to the droplet 130 and/or relative to the respective plates 110, 120. In some examples, the filler may affect the pulling forces (F), may resist droplet evaporation, and/or facilitate sliding of the droplet and maintaining droplet integrity.

In some examples, the distance (D1) between the respective plates 110, 120 may comprise between about 50 to about 500 micrometers, between about 100 to about 150 micrometers, or about 200 micrometers. In some examples, the droplet 130 may comprise a volume of about less than a microliter, such as between about 10 picoliters and about 30 microliters. In some examples, the distance (D1) between the respective plates 110, 120 may comprise between about 50 micrometers to about 1000 micrometers, between about 100 to about 500 micrometers, or about 200 micrometers. In some examples, the droplet 130 may comprise a volume of between about 10 picoliters and about 30 microliters. However, it will be understood that in some examples, the consumable microfluidic device 102 is not strictly limited to such example volumes or dimensions.

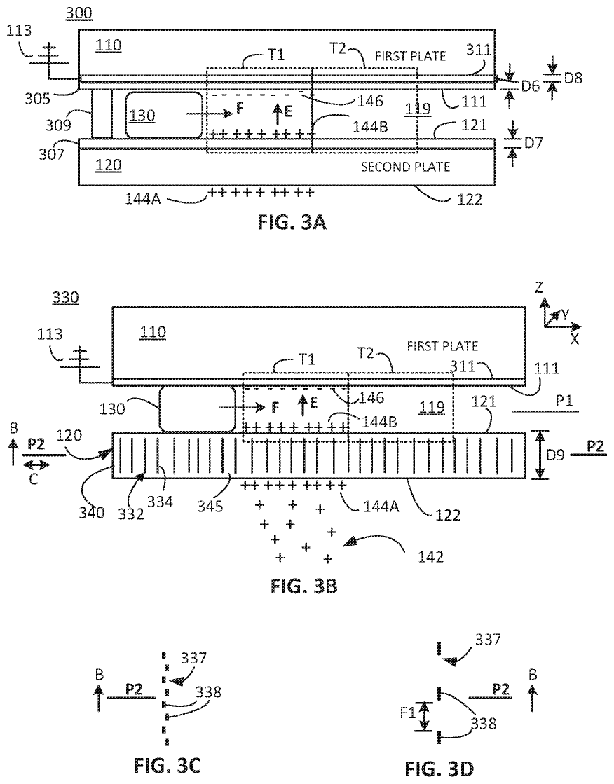

In some examples, the first plate 110 may be grounded, i.e. electrically connected to a ground element 113, which is also later shown in other FIGS, such as element 113 in FIGS. 3A, 3B, etc. In some examples, the first plate 110 may comprise a thickness (D4) of about 100 micrometers to about 3 millimeters, and may comprise a plastic or polymer material. In some examples, the first plate 100 may comprise a glass-coated, indium tin oxide (ITO). As noted later in association with at least FIG. 2, the thickness (D4) of first plate 110 may be implemented to accommodate fluid inlets (e.g. 221A, 223A, etc. in FIG. 2), to house and/or integrate sensors into the first plate 110, and/or to provide structural strength. In some examples, the sensors may sense properties of the fluid droplets, among other information.

In some examples, the addressable charge depositing unit 140 may be brought into a spaced apart relationship relative to the exterior surface 122 of the second plate of the example arrangement 101, as represented by the distance D2. In some examples, the distance D5 may comprise about 0.25 millimeters (e.g. 0.23, 0.24, 0.25, 0.26, 0.27) to about 2 millimeters (e.g. 1.9, 1.95, 2, 2.05. 2.1). In some such examples, the addressable charge depositing unit 140 may be supported by, or within, a frame 133 and the consumable microfluidic receptacle 102 may be releasably supportable by the frame 133 to place the consumable microfluidic receptacle 102 and the addressable charge depositing unit 140 into charging relation to each other.

As further shown in FIG. 1, upon the consumable microfluidic receptacle 102 and the addressable charge depositing unit 140 being appropriately positioned relative to each other, the addressable charge depositing unit 140 may emit airborne charges 142 toward and onto the exterior surface 122 of the second plate 120, which may then be referred to as deposited charges 144A. In particular, the emitted charges 142 are directed to a target position shown in dashed lines T1, which is immediately adjacent to the droplet 130.

With first plate 110 being grounded, counter negative charges 146 develop on surface 111 of the first plate 110 to cause an electric field (E) between the respective first and second plates 110, 120, which creates a pulling force (F) to draw the droplet 130 forward into the target position T1. With the presence of the counter charges 146 at first plate 110, the deposited charges 144A may quickly advance from the exterior surface 122 to the interior surface 121 of the second plate 120.

In some examples, the pulling force (F), which causes movement of droplet 130 upon inducing the electric field (E), may comprise electrowetting forces. In some such examples, the electrowetting forces may result from: (1) modification of the wetting properties of the interior surface 121 of second plate 120 and/or surface 111 of plate 111 upon application of the electric field (E); (2) counter charges introduced in the droplet 130, which may result from electrical conductivity within the droplet 130 in some examples and/or from induced dielectric charges within the droplet 130 in some examples; and/or (3) a minimization of the potential energy of the system including the electric field (E) between the counter charges 146 (e.g. negative) and the charges 144A (144B) (e.g. positive).

Depending on the electrical properties of the second plate 120, charges 144A may partially move, or completely move, towards counter charges 146 to become present at the location 1448 on surface 121, as shown in FIG. 1.

In some examples, the deposited charges 144A at second plate 120 may comprise between on the order of tens of volts and on the order of a few hundred volts of charges on the second plate 120. In some examples, the deposited charges 144A may comprise 1000 Volts. It will be understood that the deposited charges 144A will dissipate, e.g. discharge, over time by flowing to the ground 113 and/or by the addressable charge depositing unit 140 emitting opposite charges (e.g. negative charges). In particular, in some examples the deposited charges 144A may be discharged at a rate that is slower than the movement of the liquid droplet 130 (which is on the order of milliseconds) but faster than the next application of charges by the addressable charge depositing unit 140, which may comprise on the order of tens of milliseconds, depending on the particular type or characteristics of the addressable charge depositing unit 140 and the response time of the second plate 120. As the droplet 130 moves into the area of the charges (i.e. the target position T1), the electric field E drops due to an increased dielectric constant occurring in the effective capacitor which is formed between the respective first and second plates 110, 120, and in some examples because of leakage through the droplet 130 to ground via the first plate 110.

It will be further understood that charges (e.g. 144A) deposited on the second plate 120 (by the charge depositing unit 140) will be significantly discharged or at least be discharged to a level at which their voltage is significantly lower than the voltage to be applied before the next electrowetting-caused pulling movement of the droplet 130 occurs to the next target position T2.

In some examples, discharge of the second plate 120 depends on a response time of the second plate 120, which may behave like an RC-type circuit, in some examples. For instance, in some examples, in which the second plate 120 comprises a resistivity of 10⁹ ohm cm and has a thickness (D3) of 30 micrometer, the second plate 120 may exhibit a 10 millisecond response time, i.e. time to discharge the deposited charges 144A. In some examples, the second plate 120 may comprise a plastic material, such as but not limited to, materials such as polypropylene, Nylon, polystyrene, polycarbonate, polyurethane, epoxies, or other plastic materials which are low cost and available in a wide range of conductivities. In some examples, the second plate 120 may comprise a transparent material.

In some examples, the second plate 120 may comprise a resistivity of about 10⁶ to about 10¹² Ohm-cm. In some such examples, with this resistivity the second plate 120 may sometimes be referred to as being partially electrically conductive, partially conductive, and the like. In some examples, a conductivity within the desired range noted above may be implemented via mixing into a plastic material some conductive carbon molecules, carbon black pigments, carbon fibers, or carbon black crystal.

In some examples, the addressable charge depositing unit 140 also may be used to neutralize charges on second plate 120. In particular, in some arrangements, such as when the response time of the second plate 120 (to discharge charges 144A in an appropriate period of time) is slow or for other strategic reasons, the addressable charge depositing unit 140 may be used to neutralize residual charges so as to prepare the microfluidic receptacle (e.g. portion of a microfluidic device) to receive a deposit of fresh charges in preparation of causing further electrowetting movement of the droplet 130 to a next target position (e.g. T2).

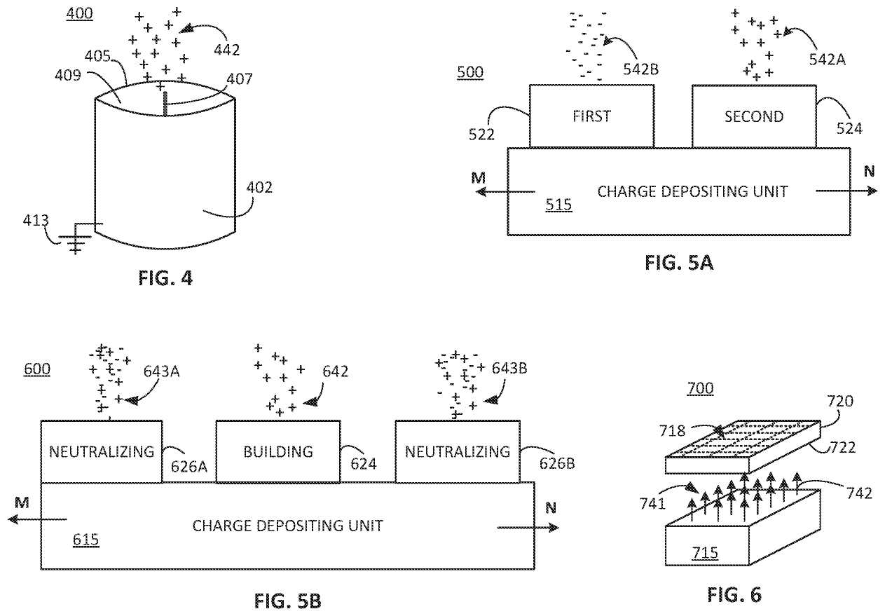

It will be understood that in some examples, the addressable charge depositing unit 140 may be mobile and the microfluidic receptacle 102 may be stationary while performing microfluidic operations, while in some examples, the addressable charge depositing unit 140 may be stationary and the microfluidic receptacle 102 is moved relative to the addressable charge depositing unit 140 during microfluidic operations. In some examples, the frame 133 (FIG. 1) may including portions, mechanisms, etc. which may facilitate relative movement between the consumable microfluidic receptacle 102 and the charge depositing unit 140. At least some such examples may be implemented in association with one of the addressable charge depositing units as described in association with at least FIGS. 4-8.

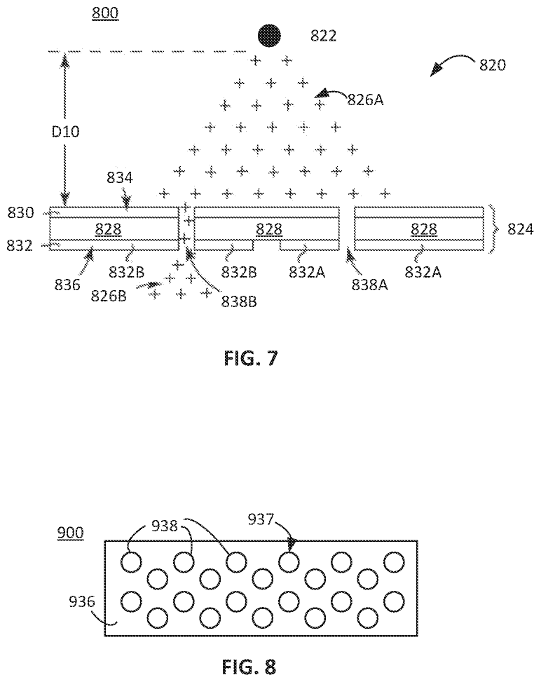

In some examples, both of the addressable charge depositing unit 140 and the microfluidic receptacle 102 are stationary during microfluidic operations, with the addressable charge depositing unit 140 being arranged in a two-dimensional array to deposit charges in any desired target area of the microfluidic receptacle in order to perform a particular microfluidic operation or sequence of microfluidic operations. At least some example implementations of such a two-dimensional array may comprise at least some of the substantially the same features and attributes as described in association with at least FIGS. 6, 7, and/or 8.

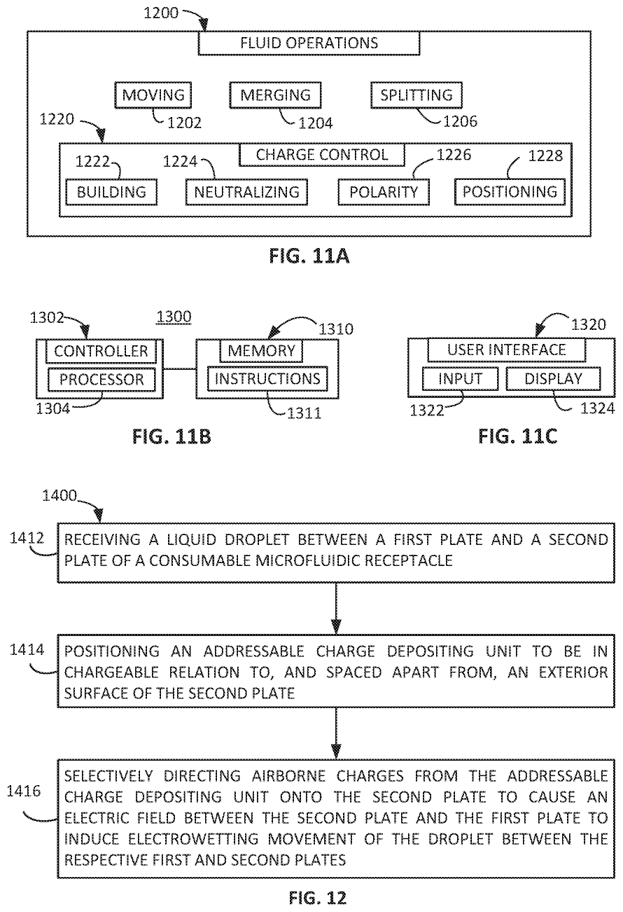

In some examples, such microfluidic operations to be performed via the consumable microfluidic receptacle 102 and an addressable charge depositing unit (e.g. 140 in FIG. 1) may be implemented in association with a control portion, such as but not limited to control portion 1300 in FIG. 11B and/or in association with a fluid operations engine 1200 in FIG. 11A.

FIG. 2 is a diagram including an elevational view schematically representing an example microfluidic device 200. In some examples, the microfluidic device 200 comprises at least some of substantially the same features and attributes as the consumable microfluidic receptacle 102 in FIG. 1. In particular, in some examples, the microfluidic receptacle 102 in FIG. 1 may comprise at least a portion of the example microfluidic device 200.

As shown in FIG. 2, the microfluidic device 200 comprises a frame 205 within which is formed an array 215 of interconnected passageways 219A, 219B, 219C, 219D, 219E, with each respective passageway being defined by a series of target positions 217. In some examples, the respective passageways 219A-219E are defined between a first plate (like first plate 110 in FIG. 1) and a second plate (like second plate 120 in FIG. 1), with each target position 217 corresponding to a target position (e.g. T1 or T2) shown in FIG. 1 at which a droplet (e.g. 130 in FIG. 1) may be positioned. In some examples, each target position 217 may comprise a length of about 500 to about 1500 micrometers while in some examples the length may be about 750 to about 1250 micrometers. In some examples, the length may be about 1000 micrometers. Meanwhile, in some examples, each target position 217 may have a width commensurate with the length, such as the above-noted examples.

As previously noted in association with FIG. 1, the respective target positions 217 and the passageways 219A-219E do not include control electrodes for moving droplets 130. Rather, droplets 130 are moved through the various passageways 219A, 219B, 219B, 219D, 219E via electrowetting forces caused by directing airborne charges from the non-contact airborne charge depositing unit 140, as described in association with FIG. 1. Accordingly, via the use of such an externally-applied electric field, the droplet(s) 130 move through the passageways via electrowetting forces without any control electrodes lining the paths defined by the various passageways 219A-219E.

As further shown in FIG. 2, at least some of the respective target positions 217, such as at positions 221A, 221B, 223A, and/or 223B may comprise an inlet portion which can receive a droplet 130 to begin entry into the passageways 219A-219E to be subject to microfluidic operations such as moving, merging, splitting, etc. In some examples, some of the example positions 221A, 221B, 223A, 223B may comprise an outlet portion, from which fluid may be retrieved after certain microfluidic operations.

It will be understood that in some examples, the consumable microfluidic device 200 may comprises features and attributes, such as not limited to additional structures and/or functions, in addition to those described in association with FIGS. 1-2. For example, in some instances, prior to receiving droplets 130, the microfluidic device 200 may comprise at least one fluid reservoir R at which various fluids (e.g. reagents, binders, etc.) may be stored and which may be released into at least one of the passageways 219A-219E. In some examples, release of such reagents or other materials may be caused by the same externally-caused electrowetting forces as previously described to movement droplet 130. Moreover, in some examples, at least some of the passageways 219A-219E may form or define a lateral assay flow device in which some reagents, etc. may already be present at various target positions 217 within a particular passageway (e.g. 219A-219E) such that upon movement of various droplets 130 relative to such target positions 217 may result in desired reactions to effect a lateral flow assay. However, in some examples, the microfluidic device 200 does not store any liquids on board, and any liquids on which microfluidic operations are to be performed are added, such as in the example inlet locations 221A, 221B, 223A, 223B, as previously described.

Via the externally-caused electrowetting movement of the respective droplets within the passageways 219A-219E, various microfluidic operations of moving, merging, splitting may be performed within microfluidic device 200 to cause desired reactions, etc. With this in mind, in some examples a portion of the consumable microfluidic device 200 may comprise at least one sensor (represented by indicator S in FIG. 2) to facilitate tracking the status and/or position of droplets within a microfluidic device, as well as for determining a chemical or biochemical result ensuing from the various microfluidic operations, such as merging, splitting, etc. In some such examples, such sensors may be incorporated into the first plate 110 (FIG. 1) so as to not interfere with the deposit of charges, migration of charges, neutralization of charges, etc. occurring at or through the second plate 120 (FIG. 1). In some examples the sensor(s) may include external sensors, like optical sensors. In some such examples, such external sensors may be used to sense attributes of a fluid retrieved from an above-described outlet portion.

In some examples, such microfluidic operations to be performed via the microfluidic device 200 and an addressable charge depositing unit (e.g. 140 in FIG. 1) may be implemented in association with a control portion, such as but not limited to control portion 1300 in FIG. 11B and/or in association with a fluid operations engine 1200 in FIG. 11A.

As previously noted in association with FIGS. 1-2, it will be understood that an addressable charge depositing unit 140 may be used in a non-contact manner to apply charges to build a charges on a second plate 120 (or to neutralize charges) to cause electrowetting movement of droplets through the microfluidic device 200, and it is understood that the addressable charge depositing unit 140 may be mobile or stationary while the microfluidic device 200 may be mobile or stationary as well. With this in mind, the addressable charge depositing unit 140 may comprise a wide variety of configurations, as further later described in association with at least FIGS. 4-8, in order to achieve such application of charges for building charges and/or neutralizing charges.

In some examples, as shown in FIG. 1, each target position (e.g. T1,T2, etc.) may comprise a length (D2) which may comprise a length expected to be approximately the same size (e.g. length D2) as the droplet 130 to be moved. In view of the example volumes of droplets noted above, the length (D2) of each target position (e.g. T1, T2, etc.) may comprise between about 50 micrometers to about 5 millimeters, and may comprise a width similar to its length in some examples. In some examples, the target position also may sometimes be referred to as a droplet position.

In some examples, the length (D2) of the droplet in passageway 119 may sometimes be referred as a length scale of the droplet (or target position of a droplet). In sharp contrast to some other devices which utilize an array of control electrodes and which involve spacing between adjacent control electrodes because of manufacturing limitations, in at least some examples of the present disclosure, the target positions (e.g. T1, T2) may be immediately adjacent each other with virtually no spacing therebetween. Accordingly, at least some examples of the present disclosure do not face at least some of the challenges in moving droplets that may otherwise be posed by a distance between adjacent electrodes in such devices employing control electrodes.

In some examples, the example arrangements of the present disclosure to cause electrowetting movement of droplets stand in sharp contrast to some microfluidic devices which rely on dielectrophoresis to produce movement of particles. At least some such dielectrophoretic devices comprise a distance between control electrodes (of a printed circuit board which form one of the microfluidic plates) which is substantially greater (e.g. 10 times, 100 times, etc.) than a length scale (e.g. size) of a particle within a liquid to be moved. For instance, the distance between control electrodes (in some dielectrophoretic devices) may be on the order of hundreds (i.e. 100's) of micrometers, whereas the length scale of such particles may comprise on the order of hundreds (i.e. 100's) nanometers. In some such devices, the distance between electrodes in a dielectrophoretic device may sometimes be referred to as a length scale of such electrodes or as a length scale of the gradient (i.e. gradient length scale).

For comparison purposes to some dielectrophoretic devices, a droplet of liquid to be moved via electrowetting forces in at least some examples of the present disclosure may comprise a thickness between a first plate 110 and second plate 120 of about 200 micrometers, and a length (or width) extending across a target position (e.g. T1, T2) (i.e. droplet position) of about 2 millimeters, in some examples. In sharp contrast, dielectrophoresis may cause movement of a particle within a mass of fluid, where such particle may be about 100 nanometers diameter (or length, width, or the like) and many particles may reside within a droplet of liquid. However, the dielectrophoretic device does not generally cause movement of an entire fluid mass.

FIG. 3A is a diagram including a side view schematically representing an example consumable microfluidic receptacle 300. In some examples, the example microfluidic receptacle 300 may comprise, and/or be employed via, at least some of substantially the same features and attributes as the examples previously described in association with at least FIGS. 1-2. Accordingly, it will be understood that the consumable microfluidic receptacle 300 may comprise a portion of a microfluidic device, such as microfluidic device 200 in FIG. 2. In some examples, microfluidic receptacle 300 may comprise a first coating 305 on interior surface 111 of first plate 110 and/or a second coating 307 on interior surface 121 of second plate 120, with such coatings arranged to facilitate electrowetting movement of droplets 130 through a passageway 119 defined between the respective plates 110, 120.

In some examples, at least one of the respective coatings 305, 307 may comprise a hydrophobic coating, while in some examples, at least one of the respective coatings 305, 307 may comprise a low contact angle hysteresis coating. In some examples, a low contact angle hysteresis coating may correspond to contact angle hysteresis of less than about 30, 29, 28, 27, 26, 25, 24, 23, 22, 21, or 20 degrees. In some examples, the contact angle hysteresis may comprise less than about 20, 19, 18, 17, 16, or 15 degrees. In some example implementations including coatings 305, 307, an oil filler is provided within the passageways 219A-219E, which further enhances the effect of the coatings 305, 307. In some examples, the coating 305 and coating 307 may have respective thicknesses of D6, D7 on the order of one micrometer, but in some examples the thicknesses D6, D7 can be less than one micrometer, such as a few tens of nanometers. In some examples, the thicknesses can be greater than one micrometer, such as a few micrometers.

As further shown in FIG. 3A, in some examples the consumable microfluidic receptacle 300 may comprise an electrically conductive layer 311, by which the first plate 110 may be electrically connected to a ground element 113. In some such examples, the electrically conductive layer 311 may comprise a material such an indium titanium oxide (ITO) which is transparent and may have a thickness D8 on the order of a few tens of nanometers. While not shown in FIGS. 1-2, 6, and 9-10 for illustrative simplicity, it will be understood that in some examples the electrically conductive layer 311 may form a portion of (or a coating on) the first plate (e.g. 110) in any one or all of the various example consumable microfluidic receptacles (of an example microfluidic device) of the present disclosure.

In some examples, the consumable microfluidic receptacle 300 may comprise spacer element(s) 309 at periodic locations or non-periodic locations between the first plate 110 and the second plate 120 to maintain the desired spacing between the respective plates 110,120 and/or to provide structural integrity to the microfluidic receptacle 300. In some examples, the spacer element(s) 309 may be formed as part of forming one or both of plates 110, 120, such as via a molding process. It will be understood that such spacer element(s) may form part of any of the other example microfluidic receptacles of the present disclosure.

FIG. 3B is a diagram including a side view schematically representing an example consumable microfluidic receptacle 330 includes an anisotropic conductivity layer. In some examples, the example consumable microfluidic receptacle 330 may comprise, and/or be employed via, at least some of substantially the same features and attributes as the examples previously described in association with at least FIGS. 1-3A. In addition, the example microfluidic receptacle 330 may comprise the second plate 120 (e.g. 120 in FIGS. 1, 3A) being formed as an anisotropic conductivity layer 340.

In some examples, as shown in FIG. 3B, the anisotropic conductivity layer 340 comprises a conductive-resistant medium 345 (e.g. partially conductive matrix) within which an array 332 of conductive elements 334 is oriented generally perpendicular to the plane (P2) through which the entire anisotropic conductivity layer 340 (e.g. second plate 120 in FIG. 3B) generally extends. In some examples, the conductive-resistant medium 345 (e.g. matrix) may comprise a bulk resistivity of about 10¹¹ Ohm-cm to about 10¹⁶ Ohm-cm. In some such examples, the conductive elements 334 may comprise a conductivity at least two orders of magnitude greater than a bulk conductivity of the conductive-resistant medium 345. In some examples, the resistant-conductive medium 345 of the layer 340 may comprise a plastic or polymeric materials, such as but not limited to, materials such as polypropylene, Nylon, polystyrene, polycarbonate, polyurethane, epoxies, or other plastic materials which are low cost and available in a wide range of conductivities. In some examples, a bulk conductivity (or bulk resistivity) within the desired range noted above may be implemented via mixing into the plastic material some conductive carbon molecules, carbon black pigments, carbon fibers, or carbon black crystal. In some examples, the conductive-resistant medium 345 may comprise a resistivity of less than 10⁹ Ohm-cm in the perpendicular direction (direction B) to P2 plane, and a larger lateral resistivity (e.g. lateral conductivity) of at least 10¹¹ Ohm-cm (direction C along plane P2). Accordingly, the lateral conductivity is at least two orders of magnitude greater than the conductivity of the conductive-resistant medium 345 in the direction perpendicular to the plane P2 (FIG. 3B).

In some examples, the relative permittivity of the conductive-resistant medium 345 of the anisotropic layer 340 (e.g. second plate 120 in FIG. 3B) may be greater than about 20. In some examples, the relative permittivity may be greater than about 25, 30, 35, 40, 45 50, 55, 60, 65, 70, or 75. In some instances, the relative permittivity may sometimes be referred to as a dielectric constant. Among other attributes, providing such relative permittivity may result in a lower voltage drop across the second plate 120. In some examples, the relative permittivity of the second plate 120 in the direction of the plane P2 may comprise lower than about 10. In some examples, it may comprise about 3.

As noted above, in some examples, the anisotropic layer 340 (e.g. second plate 120 in FIG. 3B) may comprise a low lateral conductivity (i.e. a conductivity along the plane P2, such as represented via directional arrow C) with resistivity of at least 10¹¹ Ohm-cm (similar to the bulk conductivity). In some examples, this resistivity along the plane P2 (i.e. lateral conductivity) may comprise about 10¹⁴ Ohm-cm.

In some examples, the anisotropic layer 340 (e.g. second plate 120 in FIG. 3B) may comprise a high conductivity perpendicular (direction B) to the plane P, such as a resistivity which is on the order of, or less than, 10⁹ Ohm-cm. In some examples, this resistivity may comprise 10⁶ Ohm-cm. In at least some examples, the resistivity perpendicular to the plane P2 is at least about two orders of magnitude different from (e.g. lower) than the resistively along or parallel to the plane P2. In some such examples, this relatively high conductivity perpendicular to the plane P2 may sometimes be referred to as vertical conductivity with respect to the plane P2.

In comparison to the relatively high conductivity of the conductive resistant medium 345 perpendicular to the plane P2 (direction B), the above-noted relatively low lateral conductivity (direction C) of the conductive resistant medium 345 may effectively force travel of the charges (applied by the addressable charge depositing unit 140) to travel primarily in a direction (B) perpendicular to the plane P, such that the electric field E acting within the passageway 119 (i.e. conduit) 119 may comprise an area (e.g. x-y dimensions) which are similar to the area (e.g. x-y dimensions) of each application of charges from the charge depositing unit 140 directed to a specific target position (e.g. T1, T2, etc.).

As shown in FIGS. 3B, via the example anisotropic conductivity layer 340 of second plate 120, the conductive elements 334 are aligned generally parallel to each other, in a spaced apart relationship, in an orientation generally the same as the direction (arrow B) which the charges 144A at the exterior surface 122 (of second plate 120) are to travel through second plate 120 to reach the interior surface 121 of the second plate 120. While the respective conductive elements 334 are shown as being oriented perpendicular to the plane P2, it will be understood that in some examples the conductive elements 334 may be oriented at a slight angle (i.e. slanted) which not strictly perpendicular.

Moreover, in some examples, as shown in FIG. 3C, each respective conductive element 334 may comprise an array 337 of smaller conductive particles 338 which are aligned in an elongate pattern to approximate a linear element of the type shown as element 334 in FIG. 3B. The array 337 of elements 338 may sometimes be referred to as a conductive path. In some examples, the conductive particles 338 may comprise metal beads with each bead ranging from 0.5 micrometers to about 5 micrometers in diameter (or a greatest cross-sectional dimension). In some such examples, these smaller conductive particles 338 may be aligned during formation of the anisotropic layer 340 via application of a magnetic field until the materials (e.g. conductive particles, conductive-resistant medium) solidify into their final form approximating the configuration shown in FIGS. 3C-3D. In contrast to the bulk resistivity of the conductive-resistant medium 345 of a resistivity of at least on the order of 10¹¹ Ohm-cm, the elongate pattern formed by array 337 of conductive particles 338 may comprise a resistivity of less than 10⁹ Ohm-cm in some examples. In some examples, the conductive particles 338 may comprise conductive materials, such as but not limited to iron or nickel. In some examples in which the conductive particles 338 are not in contact with each other, such particles 338 may be spaced apart by a distance F1 as shown in FIG. 3D, with such distances being on the order of a few nanometers in some examples. In some examples, the material (e.g. polymer) forming the conductive-resistant medium 345 of the second plate 120 is interposed between the respective conductive particles 338 of the array 337 (e.g. forming the elongate pattern) defining elements 334. In some such examples, because of this very small dimension F1 between at least some of the conductive particles 338, the conductive-resistance medium 345 interposed between the conductive particles 338 (and which would other exhibit a resistivity of at least on the order of 10¹¹ Ohm-cm in some examples) may comprise a conductive bridge (between adjacent particles 338) having a length less than about a micrometer and as such, may exhibit a much smaller resistivity which is several (e.g. 2, 3, or 4) orders of magnitude less than the resistivity otherwise exhibited by the conductive-resistant medium 345. Accordingly, even when some conductive resistant medium 345 is interspersed between some of the aligned conductive particles 338, the elongate pattern (e.g. array 337) of the conductive particles 338 still exhibits an overall conductivity perpendicular to the plane P2 (through which the second plate 120 extends) which comprises at least two orders of magnitude higher (e.g. greater) than the lateral conductivity along the plane P2.

In some examples, because of the anisotropic conductivity arrangement within the second plate 120, the second plate 120 exhibits a response time which is substantially faster than if the second plate 120 were otherwise made primarily or solely of a dielectric material or made of a partially conductive material without the conductive elements 334. Moreover, via at least some such example arrangements, the charges (e.g. 144B) dissipate over time (i.e. discharge) through the droplet 130 instead of primarily discharging through the second plate 120.

In one aspect, the anisotropic conductivity configuration of second plate 120 either may enable faster electrowetting movement of droplets 130 through passageway 119 due to higher electrical field on the droplet resulting in higher pulling forces and/or may permit use of thicker second plates 120, as desired (i.e. increasing the thickness of second plate 120). In one aspect, providing a relative thick/thicker second plate 120 enables better structural strength, integrity, and/or better mechanical control of the gap between interior surface 111 of the first plate 110 and the interior surface 121 of the second plate 120. In some examples, the second plate 120 may comprise a thickness (D3) of about 30 micrometers to about 1000 micrometers. In some examples, the thickness (D3) may comprise about 30 micrometers to about 500 micrometers. In some examples, the second plate 120 may sometimes be referred to as a charge-receiving layer and sometimes may be referred to as an anisotropic conductivity layer.

In one aspect, the anisotropic conductivity configuration (e.g. layer 340) forming second plate 120 in FIG. 3B stands in sharp contrast to at least some anisotropic conductive films (ACF) which may resemble a tape structure and involve the application of high heat and high pressure, which in turn may negatively affect the overall structure of the consumable microfluidic receptacle, such as but not limited to, any sensitive sensor elements or circuitry within the first plate 110. Moreover, at least some anisotropic conductive films (ACF) may be relatively thin and/or flexible such that they are unsuitable to stand alone as a bottom plate of a microfluidic device because they may lack sufficient structural strength and durability.

It will be understood that in some examples, a consumable microfluidic receptacle 102, 300, 330 (which may define or form part of a microfluidic device) may comprise both an anisotropic conductivity layer (e.g. 340 in FIG. 3B) and at least one of the coatings 305, 307 of the respective interior surfaces 111, 121 of the respective first and second plates 110, 120.

As previously noted, the addressable charge depositing unit 140 (FIG. 1) may comprise a wide variety of configurations, depending on the particular type of consumable microfluidic receptacle 102, whether it is stationary or mobile, etc.

FIG. 4 is an isometric view schematically representing an example addressable charge depositing unit 400. In some examples, the addressable charge depositing unit 400 may comprise one example implementation of, and/or may comprise at least some of substantially the same features and attributes as, the addressable charge depositing units described in association with at least FIGS. 1-3B.

As shown in FIG. 4, the addressable charge depositing unit 400 comprises a needle 407. The needle 407 extends at least partially through, and is exposed at, one end 405 of a cylinder 402, with the needle 407 being spaced apart from the inner wall surface 409 of the cylinder 402. Upon applying an electrical signal, a high voltage may be caused at the end of the needle 407, which in turn generates airborne charges 442 oriented to migrate toward a second plate (e.g. 120 in FIG. 1) of a consumable microfluidic receptacle 102. The generated airborne charges 442 may be positive (as shown) or negative, depending on the particular goals (e.g. building charge, neutralizing charge, etc.) for the consumable microfluidic receptacle 102. In some examples, the cylinder 402 may be electrically connected to a ground element 413 and a first voltage applied to the needle 407 may be at least one order of magnitude greater than a target second voltage (e.g. deposited charges 144A in FIG. 1) to occur at the exterior surface 122 of the second plate 120. In some such examples, the first voltage may comprise between about 1000 Volts to about 5000 Volts.

However, in some examples, the cylinder 402 is not grounded but rather an electrical signal is applied to cause the cylinder 402 to exhibit a third voltage, with the first voltage at the needle 407 being substantially greater than the third voltage. In one such example implementation, the first voltage at needle 407 may comprise about 4000 Volts while the third voltage at the cylinder 402 may comprise about 1000 Volts, while the first plate 110 is grounded.

The addressable charge depositing unit 400 may be mobile, and moved relative to a stationary microfluidic device (e.g. consumable microfluidic receptacle), or the addressable charge depositing unit 400 may be stationary, and the microfluidic device (e.g. consumable microfluidic receptacle) may be moved relative to the addressable charge depositing unit 400. In either case, via such relative movement, the addressable charge depositing unit 400 may selectively generate airborne charges 442 to cause electrowetting movement of droplets within and through a consumable microfluidic receptacle, with the addressable charge depositing unit 400 being operated to generate negative or positive charges, depending on particular goals to build charges or neutralize charges.

FIG. 5A is a diagram 500 including a side view schematically representing an example addressable charge depositing unit 515. In some examples, the addressable charge depositing unit 515 may comprise one example implementation of, and/or may comprise at least some of substantially the same features and attributes as, the addressable charge depositing units described in association with at least FIGS. 1-3B. In some examples, the addressable charge depositing unit 515 comprises a first charge unit 522 and a second charge unit 524, each of which may generate airborne charges having a first polarity or an opposite second polarity, as desired. In some examples, the respective charge units 522, 524 may comprise and/or sometimes be referred to as an ion head, ion-generating head, and the like. For example, if the addressable charge depositing unit 515 were moved in a first direction (directional arrow M), the first charge unit 522 could emit airborne charges of a first polarity 542B (e.g. negative in some examples) to deposit charges in order to neutralize any residual charges present at second plate 120. Next, the following second charge unit 524 can emit airborne charges of an opposite second polarity 542A (e.g. positive in this example) to deposit and build charges at the exterior surface 122 of the second plate 120 in order to cause an electric field (as represented by directional arrow E) between the respective second and first plates 120, 110. This electric field (E) may induce electrowetting movement of droplets 130 within passageways of a consumable microfluidic receptacle for microfluidic operations.

Alternatively, upon moving the addressable charge depositing unit 515 in an opposite second direction (directional arrow N), the second charge unit 524 may generate airborne charges having the first polarity (e.g. negative) 542B to deposit charges in order to neutralize any residual charges present at second plate 120. Next, the following first charge unit 522 can emit airborne charges of an opposite second polarity (e.g. positive in this example) 542A to deposit and build charges at the exterior surface 122 of the second plate 120 in order to cause an electric field (between the respective second and first plates 120, 110) to induce electrowetting movement of droplets 130 within passageways of a consumable microfluidic receptacle of a microfluidic device.

Accordingly, by altering the respective roles of the first and second charge units 522, 524 in view of the particular direction of movement of the addressable charge depositing unit 515, the addressable charge depositing unit 515 may generate the appropriate stream of airborne charges to either neutralize charges or build charges to control electrowetting movement of droplets within the microfluidic device as desired.

FIG. 5B is a diagram 600 including an isometric view schematically representing an example addressable charge depositing unit 615. In some examples, the addressable charge depositing unit 615 may comprise one example implementation of, and/or may comprise at least some of substantially the same features and attributes as, the addressable charge depositing units described in association with at least FIGS. 1-3B, 5A. In some examples, the addressable charge depositing unit 615 comprises a charge building element 624 and a pair of charge neutralizing elements 626A, 626B on opposite sides of the charge building element 624. In some examples, the respective charge building or neutralizing elements 624, 626A, 626B may comprise and/or sometimes be referred to as an ion head, ion-generating head, and the like.

In some examples, the charge building element 624 may generate airborne charges of a first polarity (e.g. positive) 642 to deposit and build charges 144A on an exterior surface 122 of a second plate 120 (e.g. FIG. 1) to cause an electric field to control electrowetting movement of droplets within a consumable microfluidic receptacle of a microfluidic device. However, prior to doing so, charges on the second plate 120 may be neutralized as desired via operation of the first or second charge neutralizing element 626A, 626B, depending on the direction of movement of the addressable charge depositing unit 615. For instance, upon moving in the first direction F, the first charge neutralizing unit 626A may emit charges 643A to neutralize charges on the second plate 120 (and first plate 110). In some examples, as shown in FIG. 5B, the charges 643A may comprise charges of both a first and second polarity (e.g. positive and negative) within an AC signal. The combination of opposite charges may more effectively neutralize any charges on the second plate 120 and/or the first plate 110. However, in some examples, the first charge neutralizing element 626A may emit airborne charges of a single polarity (e.g. negative) which are opposite the polarity (e.g. positive) of the charges 642 emitted by the charge building element 624.

Alternatively, upon moving the addressable charge depositing unit 615 in the opposite second direction S, the second charge neutralizing element 626B may emit charges 643B to deposit charges in order to neutralize residual charges on the second plate 120 (and first plate 110). In some examples, as shown in FIG. 5B, the charges 643B may comprise charges of both a first and second polarity (e.g. positive and negative) within an AC signal. The combination of opposite charges may effectively neutralize any charges on the second plate 120 and/or the first plate 110. However, in some examples, the second charge neutralizing element 626B may emit airborne charges of a single polarity (e.g. negative) which are opposite the polarity (e.g. positive) of the charges 642 emitted by the charge building element 624.

Accordingly, the addressable charge depositing unit 615 of FIG. 5B is equipped for efficient, effective charge neutralization and/or charge building regardless of the particular direction (e.g. F or S) of movement of the charge depositing unit 615 to control electrowetting movement of droplets within a microfluidic device.

FIG. 6 is a diagram including a side view schematically representing an example two-dimensional addressable charge depositing unit 715 in charging relation to a second plate 720 of a consumable microfluidic receptacle (e.g. 102 in FIG. 1). In some examples, the addressable charge depositing unit 715 may comprise one example implementation of, and/or may comprise at least some of substantially the same features and attributes as, the addressable charge depositing units described in association with at least FIGS. 1-4. Meanwhile, the second plate 720 may comprise one example implementation of, and/or may comprise at least some of substantially the same features and attributes as, the consumable microfluidic receptacle 102 described in association with at least FIGS. 1-4.

As shown in FIG. 6, addressable charge depositing unit 715 comprises a two dimensional array 741 of addressable charge depositing elements as represented by the arrows 742. The array 741 comprises a size and a shape to cause electrowetting movement of droplets 130 to any one target position (e.g. 217 in FIG. 2) of a corresponding array 718 of target droplet positions (e.g. 217 in FIG. 1) of the consumable microfluidic receptacle 720. In some examples, each addressable charge depositing element 742 may correspond to an addressable charge depositing unit 400 in FIG. 4, which may be operated to generate airborne charges (of a desired first polarity or opposite second polarity) in order to deposit and build charges on an exterior surface 722 of second plate 720 (of a consumable microfluidic receptacle) to cause a desired direction of movement of a droplet along a passageway (e.g. 219A-219E) within the consumable microfluidic receptacle. In some such examples, any one of the addressable charge depositing elements 742 also may be operated in a charge neutralizing mode, to emit single polarity charges (e.g. negative), or to emit charges of both a first and second polarity (e.g. negative, positive) via an AC signal in a manner similar to the first and second charge neutralizing units 626A, 626B shown in FIG. 5B, in some examples.

Via the two-dimensional arrangement shown in FIG. 6, both the second plate 720 of the microfluidic device and the addressable charge depositing unit 715 remain stationary while the array 741 of addressable charge depositing elements 742 may be selectively operated (e.g. individually controllable) to control electrowetting movement for any or all of the target positions (e.g. 217 in FIG. 2) of the second plate 720 of the consumable microfluidic receptacle (e.g. 102 in FIG. 1).

In some examples, the arrangement described in FIGS. 7-8 may comprise one example by which the two-dimensional array 741 of addressable charge depositing elements 742 may be implemented.

FIG. 7 is a diagram 800 schematically illustrating an example addressable charge depositing unit 820. In some examples, the addressable charge depositing unit 820 may comprise at least some of substantially the same features and attributes as, the addressable charge depositing units described in association with at least FIGS. 1-6. In some examples, the addressable charge depositing unit 820 may comprise one example implementation of at least a portion of the two-dimensional array of the addressable charge depositing unit in FIG. 6.

Addressable charge depositing unit 820 includes a corona generating device 822 to generate charges 826 and an electrode grid array 824. The term “charges” as used herein refers to ions (+/−) or free electrons, and in FIG. 7 the corona generating device 822 generates charges 826, which may be positive (as shown) or negative, as desired. Electrode array 824 is held in spaced apart relation to device 822 by a distance D10. In one example, device 822 is a corona generating device, such as a thin wire that is less than 100 micrometers in diameter and operating above its corona generating potential. In some examples, while not shown in FIG. 7, device 822 generates negative charges that move under existing electrical fields.

In some examples, electrode array 824 includes a dielectric film 828, a first electrode layer 830, and a second electrode layer 832. Dielectric film 828 has a first side 834 and a second side 836 that is opposite first side 834. Dielectric film 828 has holes or nozzles 838A and 838B that extend through dielectric film 828 from first side 834 to second side 836. In one example, each of the holes 838A and 838A is individually addressable to control the flow of electrons through each of the holes 838a and 838b separately. Accordingly, any one of the holes 838A, 838B or multiple holes 838A, 838B may be closed or opened, as desired.

First electrode layer 830 is on first side 834 of dielectric film 828 and second electrode layer 832 is on second side 836 of dielectric film 828. First electrode layer 830 is formed around the circumferences of holes 838A and 838B to surround holes 838A and 838B on first side 834. Second electrode layer 832 is formed into separate electrodes 832A and 832B, where electrode 832A is formed around the circumference of hole 838A to surround hole 838A on second side 836 and electrode 832B is formed around the circumference of hole 838B to surround hole 838B on second side 836. Via this juxtaposition with the electrodes, the holes 838A, 838B may sometimes be referred to as electrode nozzles.

In operation, an electrical potential between first electrode layer 830 and second electrode layer 832 controls the flow of charges 826 from device 822 through holes 838A, 838B in dielectric film 828. In one example, electrode 832A is at a higher electrical potential than first electrode layer 830 and the charges 826 (e.g. positive) are prevented or blocked from flowing through hole 838A. In one example, electrode 832B is at a lower electrical potential than first electrode layer 830 and the charges 826 flow through hole 838B and outwardly to be directed in an airborne manner onto a second plate 120 of a consumable microfluidic receptacle.

Because FIG. 7 presents an end view of the charge unit 820, it will be understood that the electrode nozzles 838A, 838B may be representative of a two-dimensional array of multiple electrode nozzles, each of which are individually controllable to selectively emit the airborne charges 826A of a particular selectable polarity (e.g. negative or positive) being generated by element 822.

FIG. 8 a diagram including a top view schematically representing an example array 937 of electrode nozzles 938 of an example addressable charge depositing unit 900. The array 937 may comprise one example implementation of an array of electrode nozzles (e.g. 838A, 838B in FIG. 7) in which the electrode nozzles 938 in FIG. 8 generally correspond to the representative electrode nozzles 838A, 838B in FIG. 7. Moreover, the example array 937 in FIG. 8 may comprise one example implementation of at least a portion of the two-dimensional array 741 in FIG. 6 in which each addressable charge depositing element 742 may correspond to a respective one of the electrode nozzles 938 in the example array 937 of FIG. 8. Similarly, in some examples the body 936 shown in FIG. 8 may comprise a supporting structure and elements which generally corresponds the structures (e.g. dielectric film 828, electrode plates, etc.) which form the overall structure of electrode array 824 in FIG. 7.

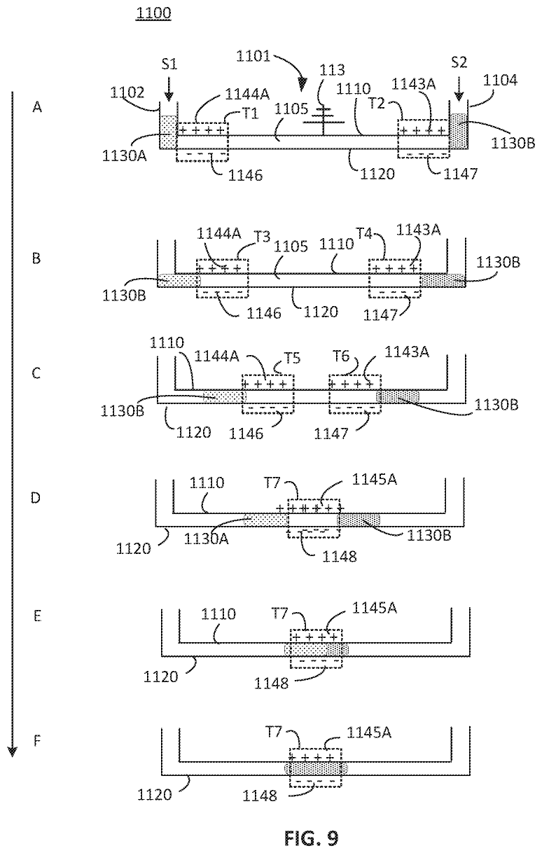

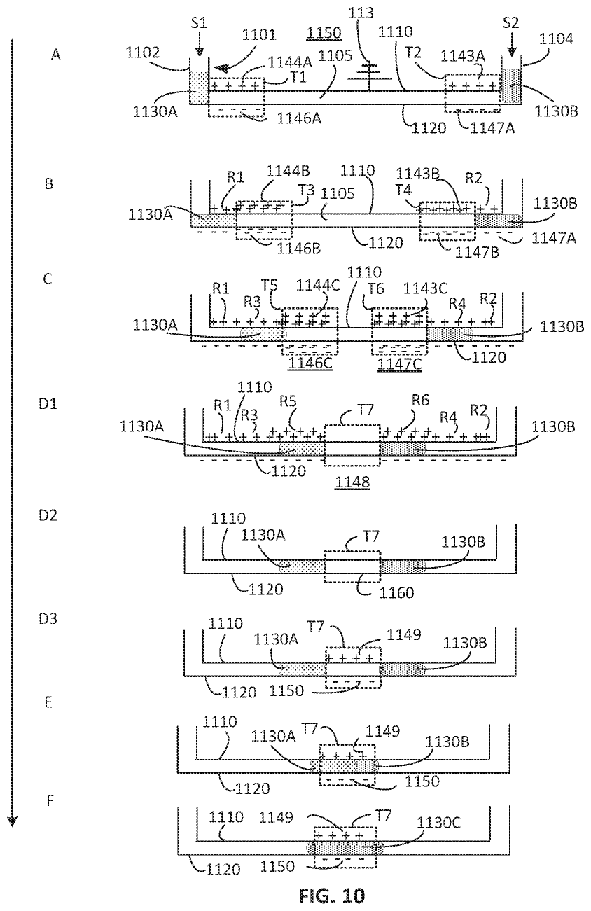

FIGS. 9 and 10 are each a diagram including a series of frames A, B, C, D, E, F (e.g. side views) schematically representing an example device and/or example method of microfluidic operation exhibiting different stages of electrowetting movement, which is controlled via depositing airborne charges to build charges and/or neutralize charges on a second plate of a consumable microfluidic receptacle 1101. In the particular examples of FIGS. 9 and 10, the example microfluidic operation based on electrowetting movement of droplets comprises the merging of two separate droplets. However, it will be understood that the same principles of operation are applicable to the splitting of a droplet or to general movement of such droplets.

As shown in the diagram 1100, FIG. 9 schematically represents a consumable microfluidic receptacle 1101 which may comprise one example implementation of, and/or at least some of substantially the same features and attributes as the example devices (e.g. consumable microfluidic receptacle) or methods as previously described in association with at least FIGS. 1-8. In one aspect, the consumable microfluidic receptacle 1101 may form a part of, or define, a microfluidic device. Accordingly, while not shown in FIGS. 9-10 for illustrative simplicity, it will be understood that one of the previously described example addressable charge depositing units may be used to deposit airborne charges in a non-contact manner to cause charges to be deposited as shown in FIGS. 9-10 either to build charges or to neutralize charges, as desired.

As shown in frame A of FIG. 9, droplets 1130A, 1130B are deposited (as represented by directional arrows S1, S2) in the respective inlets 1102, 1104 at different spaced apart portions of the consumable microfluidic receptacle 1101. In some examples, the inlets 1102, 1104 may correspond to an inlet portion like portions 221A, 221B, 223A and/or 223B of the microfluidic device in FIG. 2. As further shown in FIG. 9, via operation of an addressable charge depositing unit, near inlet portion 1102, charges 1146 (e.g. negative) are deposited at an exterior surface of a second plate 1120 (e.g. like 120 in FIG. 1) such that upon development of counter charges 1144A, an electric field is created to pull droplet 1130A, via electrowetting forces, from the inlet portion 1102 into a target portion T1 within the passageway 1105.

Similarly, near inlet portion 1104, charges 1147 (e.g. negative) are deposited at exterior portion of second plate 1120 (e.g. like an exterior surface 122 of a second plate 120 in FIG. 1) with counter charges 1143A (e.g. positive) developing to create an electric field to pull droplet 1130B, via electrowetting forces, from the inlet portion 1104 into a target portion T2 within the passageway 1105. The resulting effect is shown in frame B of FIG. 9, in which the respective droplets 1130A, 1130B have moved into the respective target positions T1, T2.

As further shown in frame B of FIG. 9, at the same time charges 1146 are deposited on second plate 1120 at target position T3 along passageway 1105 via an addressable charge depositing unit (with counter charges 1144A developing) to create an electric field, charges 1147 are deposited on second plate 1120 at target position T4 along passageway 1105 via an addressable charge depositing unit (with counter charges 1143A developing) to also create the desired electric field.

It will be further understood that in some examples, prior to the deposit of charges (e.g. negative) to build charges 1146, 1147 at a second plate 1120 as shown in frame B to cause electrowetting movement to new target positions T3 and T4, additional charges may be deposited on second plate 1120 at former target positions T1, T2 in order to neutralize any residual charges remaining from the prior instance of electrowetting movement.

The process shown in frames A and B of FIG. 9 is repeated, as shown in frames C, D, and E to use electrowetting forces to move the droplets 1130A, 1130B toward each other via the respective target positions T5, T6, T7 in passageway 1105 until they begin to merge as shown in frame E, with a completed merger shown in frame F.

It will be noted that in some examples, as shown in frames D and E, the application of building charges for both droplets 1130A, 1130B may occur in a single overlapping area, as represented by indicator 1148 at the target position T7 with the developing counter charges 1145A helping to create the electric field.

It will further understood that the illustrated electrowetting movement may applied in a similar manner to cause splitting of a droplet, in which case the sequence of building charges are deposited in opposite directions from the current location of a droplet to be split.

FIG. 10 schematically represents an example device and/or example method similar to that shown in FIG. 9, except for implementing the building of charges with some modifications compared to the example in FIG. 9. In particular, as shown in frame A of FIG. 10, a first instance of electrowetting movement of droplets 1130A, 1130B is implemented in manner similar to that shown in frame A of FIG. 9 to move droplets 1130A, 1130B into target positions T1, T2. As shown in frame A of FIG. 10, charges 1146A, 1147A are deposited, with counter charges 1144A, 1143A developing to create the electric field by which the droplets 1130A, 1130B are moved.

However, as shown in frame B of FIG. 10, the next instance of electrowetting movement occurs differently than in the example of FIG. 9. In particular, in some examples, there is no deposit of neutralizing charges at former target positions T1, T2 such that residual charges R1, R2 remain. Instead of neutralizing such residual charges R1 and R2, the example method/device deposits building charges 1146B in a volume such that the voltage at target position T3 is substantially greater than the voltage of the building charges 1146A, which were previously present at target position T1. A similar process takes place at the other end of the passageway 1105, such that the building charges 1147B at target position T4 exhibit a voltage substantially greater than the voltage of the charges 1144A, which were previously present at target position T2. In a manner similar to the prior examples (e.g. FIG. 9), it will be understood that counter charges 1144B, 1143B develop at the first plate 1110 (e.g. 110 in FIG. 1) opposite the second plate 1120 upon the depositing of charges 1146B, 1147B, respectively.

In some examples, in this context the term “substantially greater” may comprise increasing each subsequent application of charges by a voltage of 100 Volts, such as 100 Volts for charges 1146A, 200 Volts for charges 1146B (in frame B), 300 Volts for charges 1146C (frame C). In some examples, the term “substantially greater” may comprise increasing each subsequent application of charges by a voltage which differs by at least about 25 percent more, at least about 50 percent more, at least about 75 percent more, at least about 100 percent more, etc.

This substantially greater difference in the voltages between target positions T3 and T1 and in the voltages between target positions T4 and T2, as shown in frame B of FIG. 10, causes electrowetting forces to pull the respective droplets 1130A, 1130B inward through common passageway 1105 as shown in frame C, such that the droplets 1130A, 1130B arrive at their new target positions (e.g. T3, T4 in frame B).

A similar process is repeated, as shown in frame C in which charges are applied in an even greater volume to result in the voltages via the presently applied building charges 1146C at new target position T5 being substantially greater than the residual charges R3 at former target position T3 and the presently applied building charges 1147C at target position T6 being substantially greater than the residual charges R4 at former target position T4, respectively. Counter charges 1144C, 1143C develop at the first plate 1110 (e.g. 110 in FIG. 1) opposite the second plate 1120 upon the depositing of charges 1146C, 1147C, in a manner similar to prior examples, to help create the electric field. With this in mind, it will be understood that in some examples, there is no deposit of neutralizing charges at former target positions T3, T4 such that residual charges R3, R4 remain.

As can be seen in frame D1, FIG. 10 further illustrates the passageway 1105 of the consumable microfluidic receptacle 1101 (e.g. microfluidic device) after the most recently deposited charges have significantly dissipated, in which residual charges remain on the second plate (e.g. 120 in FIG. 1) as represented by indicators R5, R6 in addition to residual charges R1, R3, R2, R4. In some examples, prior to further application of fresh charges to cause further electrowetting movement of the droplets 1130A, 1130B toward each other, the example device (and/or example method) applies charges having an opposite polarity (e.g. negative) to the polarity of the residual charges R1-R6 in order to neutralize such residual charges.

The resulting neutralization of such residual charges is represented via frame D2, which depicts no charges being present along the passageway 1105 of the consumable microfluidic receptacle.

Next, as shown in frame D3, an additional deposit of charges 1150 (e.g. negative) is made on second plate 1120 at target position T7 with counter charges 1149 (e.g. positive) developing, which causes an electric field between the respective plates 1120, 1110 forming passageway 1105 to cause electrowetting forces to pull the respective droplets 1130A, 1130B toward each other to begin merging with each other, as shown in frame E of FIG. 10. The completed merger of the droplets 1130A, 1130B is shown in frame F as merged droplet 1130C.

As previously noted in association with at least FIG. 9, the examples shown in the frames A-F of FIG. 10 of moving and merging droplets are merely illustrative of the principles of electrowetting movement caused by the application of airborne charges from a non-contact addressable charge depositing unit to perform many types of microfluidic operations, such as splitting droplets, moving droplets (without necessarily merging or splitting them), etc.

With regard to the examples associated with at least FIGS. 1-3B and 9-10, in some examples deposited charges and developed counter charges (which cause an electric field to move a liquid droplet) may be applied in a manner in which the deposited charges (and developed counter charges) for one target position (e.g. T2) will overlap with deposited charges (and developed counter charges) for a previous target position (e.g. T1). In one aspect, such overlapping of the deposited charges (and respective counter charges) may enhance electrowetting movement or start of electrowetting movement of the liquid droplet. In some such examples, this overlapping of deposited charges or overlapping of deposited charge location (and respective counter charges) may particularly enhance initiation and/or continued movement of a droplet or a smaller-sized droplet. In one aspect, this behavior is enabled by the ability to adjust the location of the next charge deposition T2 or its size, which cannot be performed via some devices which utilize a fixed array of control electrodes (which also are spaced apart) connected to a power supply.

FIG. 11A is a block diagram schematically representing an example fluid operations engine 1200. In some examples, the fluid operations engine 1200 may form part of a control portion 1300, as later described in association with at least FIG. 11B, such as but not limited to comprising at least part of the instructions 1311. In some examples, the fluid operations engine 1200 may be used to implement at least some of the various example devices and/or example methods of the present disclosure as previously described in association with FIGS. 1-10 and/or as later described in association with FIGS. 11B-12. In some examples, the fluid operations engine 1200 (FIG. 11A) and/or control portion 1300 (FIG. 11B) may form part of, and/or be in communication with, an addressable charge depositing unit and/or a consumable microfluidic receptacle, such as the devices and methods described in association with at least FIGS. 1-10.

As shown in FIG. 11A, in some examples the fluid operations engine 1200 may comprise a moving function 1202, a merging function 1204, and/or a splitting function 1206, which may track and/or control electrowetting-caused manipulation of droplets within a microfluidic device, such as moving, merging, and/or splitting, respectively.

In some examples, the fluid operations engine 1200 may comprise a charge control engine 1220 to track and/or control parameters associated with operation of an addressable charge depositing unit to build charges (parameter 1222) or neutralize charges (parameter 1224) on a consumable microfluidic receptacle (of a microfluidic device), as well as to track and/or control the polarity (parameter 1224) of such charges. In some examples, a positioning parameter (1226) of the charge control engine 1220 is to track and/or control positioning (1226) of an addressable charge depositing unit and a consumable microfluidic receptacle relative to each other to implement such building or neutralizing of charges.

It will be understood that various functions and parameters of fluid operations engine 1200 may be operated interdependently and/or in coordination with each other, in at least some examples.

FIG. 11B is a block diagram schematically representing an example control portion 1300. In some examples, control portion 1300 provides one example implementation of a control portion forming a part of, implementing, and/or generally managing the example microfluidic devices, as well as the particular portions, components, addressable charge depositing units, charge building units, charge neutralizing units, consumable microfluidic receptacle, microfluidic operations, control portion, instructions, engines, functions, parameters, and/or methods, as described throughout examples of the present disclosure in association with FIGS. 1-11A and 11C-12. In some examples, control portion 1300 includes a controller 1302 and a memory 1310. In general terms, controller 1302 of control portion 1300 comprises at least one processor 1304 and associated memories. The controller 1302 is electrically couplable to, and in communication with, memory 1310 to generate control signals to direct operation of at least some of the example portions, components, etc. of the addressable charge depositing units, charge building units, charge neutralizing units, consumable microfluidic receptacle, microfluidic operations, control portion, instructions, engines, functions, parameters, and/or methods, as described throughout examples of the present disclosure. In some examples, these generated control signals include, but are not limited to, employing instructions 1311 stored in memory 1310 to at least direct and manage microfluidic operations via electrowetting movement in the manner described in at least some examples of the present disclosure. In some instances, the controller 1302 or control portion 1300 may sometimes be referred to as being programmed to perform the above-identified actions, functions, etc.

In response to or based upon commands received via a user interface (e.g. user interface 1320 in FIG. 11C) and/or via machine readable instructions, controller 1302 generates control signals as described above in accordance with at least some of the examples of the present disclosure. In some examples, controller 1302 is embodied in a general purpose computing device while in some examples, controller 1302 is incorporated into or associated with at least some of the example microfluidic devices, as well as the particular portions, components, addressable charge depositing units, charge building elements, charge neutralizing elements, consumable microfluidic receptacles, microfluidic operations, control portion, instructions, engines, functions, parameters, and/or methods, etc. as described throughout examples of the present disclosure.

For purposes of this application, in reference to the controller 1302, the term “processor” shall mean a presently developed or future developed processor (or processing resources) that executes machine readable instructions contained in a memory or that includes circuitry to perform computations. In some examples, execution of the machine readable instructions, such as those provided via memory 1310 of control portion 1300 cause the processor to perform the above-identified actions, such as operating controller 1302 to implement microfluidic operations, including causing electrowetting movement of droplets, via the various example implementations as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1310. The machine readable instructions may include a sequence of instructions, a processor-executable machine learning model, or the like. In some examples, memory 1310 comprises a computer readable tangible medium providing non-volatile storage of the machine readable instructions executable by a process of controller 1302. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 1302 may be embodied as part of at least one application-specific integrated circuit (ASIC), at least one field-programmable gate array (FPGA), and/or the like. In at least some examples, the controller 1302 is not limited to any specific combination of hardware circuitry and machine readable instructions, nor limited to any particular source for the machine readable instructions executed by the controller 1302.

In some examples, control portion 1300 may be entirely implemented within or by a stand-alone device.

In some examples, the control portion 1300 may be partially implemented in one of the example microfluidic operation devices (e.g. addressable charge depositing unit and/or consumable microfluidic receptacle) and partially implemented in a computing resource separate from, and independent of, the example microfluidic operation devices (e.g. addressable charge depositing unit and/or consumable microfluidic receptacle) but in communication with the example microfluidic operation devices. For instance, in some examples control portion 1300 may be implemented via a server accessible via the cloud and/or other network pathways. In some examples, the control portion 1300 may be distributed or apportioned among multiple devices or resources such as among a server, a microfluidic operation device (e.g. addressable charge depositing unit and/or consumable microfluidic receptacle), and/or a user interface.

In some examples, control portion 1300 includes, and/or is in communication with, a user interface 1320 as shown in FIG. 13C. In some examples, user interface 1320 comprises a user interface or other display that provides for the simultaneous display, activation, and/or operation of at least some of the example microfluidic devices, as well as the particular portions, components, addressable charge depositing units, charge building elements, charge neutralizing elements, consumable microfluidic receptacles, microfluidic operations, control portion, instructions, engines, functions, parameters, and/or methods, etc., as described in association with FIGS. 1-11B and 12. In some examples, at least some portions or aspects of the user interface 1320 are provided via a graphical user interface (GUI), and may comprise a display 1324 and input 1322.

FIG. 12 is a flow diagram of an example method 1400. In some examples, method 1400 may be performed via at least some of the devices, components, example microfluidic devices, addressable charge depositing units, charge building elements, charge neutralizing elements, consumable microfluidic receptacles, microfluidic operations, instructions, control portions, engines, functions, parameters, and/or methods, etc. as previously described in association with at least FIGS. 1-11C. In some examples, method 1400 may be performed via at least some of the devices, components, example microfluidic devices, as well as the particular portions, components, addressable charge depositing units, charge building elements, charge neutralizing elements, consumable microfluidic receptacles, microfluidic operations, instructions, control portions, engines, functions, parameters, and/or methods, etc. other than those previously described in association with at least FIGS. 1-11C.

As shown at 1412 in FIG. 12, in some examples method 1400 comprises receiving a liquid droplet between a first plate and a second plate of a replaceable fluid cavity. As further shown at 1414 in FIG. 12, in some examples method 1400 comprises positioning an addressable charge depositing unit to be in charging relation to, and spaced apart from, an exterior surface of the second plate. As further shown at 1416 in FIG. 12, method 1400 may further comprise selectively directing airborne charges from the addressable charge depositing unit onto the second plate to cause an electric field between the second plate and the first plate to induce electrowetting movement of the droplet between the respective first and second plates.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A digital microfluidic device comprising:
a non-contact charge depositing unit to selectively emit airborne charges of a selectable polarity; and
a support to releasably support a consumable microfluidic receptacle in spaced relation to the charge depositing unit to receive the airborne charges on a portion of the consumable microfluidic receptacle to cause an electric field within the consumable microfluidic receptacle to induce electrowetting movement of a liquid droplet within the consumable microfluidic receptacle.

2. The digital microfluidic device of claim 1, wherein the charge depositing unit comprises:
a charge building element to emit the airborne charges with the selectable polarity being a first polarity; and
a charge neutralizing element to emit the airborne charges with the selectable polarity being at least an opposite second polarity,
wherein the charge depositing unit is movable relative to the consumable microfluidic receptacle.

3. The digital microfluidic device of claim 2, wherein the charge neutralizing element comprises at least one of:
a pair of first charge neutralizing elements located on opposite sides of the charge building element, wherein each respective first charge neutralizing element is to emit the airborne charges having at least the opposite second polarity; and
a second charge neutralizing element to emit, in the form of an AC signal, both the airborne charges having the opposite second polarity and the airborne charges having the first polarity.

4. The digital microfluidic device of claim 1, wherein the charge depositing unit comprises:
a cylinder; and
a needle extending through the cylinder to generate, upon application of a first voltage to the needle, the airborne charges, wherein the first voltage is at least one order of magnitude greater than a target second voltage for the second plate,
wherein the cylinder is to be, at least one of:
grounded; or
held at a third voltage substantially less than the first voltage and substantially greater than the target second voltage.

5. The digital microfluidic device of claim 1, wherein the addressable charge depositing unit comprises:
a corona wire to generate airborne charges; and
an addressable array of individually controllable electrode nozzles to selectively permit passage of the airborne charges for deposit onto the consumable microfluidic receptacle, the addressable array of electrode nozzles being spaced apart from the consumable microfluidic receptacle.

6. A digital microfluidic device comprising:
a consumable microfluidic receptable including a ground first sheet and a second sheet spaced apart from the first sheet, the microfluidic receptacle to receive a liquid droplet between the respective first and second sheets,
wherein the second sheet comprises an at least partially conductive polymer material and an exterior surface to receive airborne charges, from a non-contact charge depositing unit spaced apart from an exterior surface of the second sheet, to produce an electric field between the second sheet and the first sheet at a position adjacent the liquid droplet to pull the liquid droplet through the microfluidic receptacle.

7. The digital microfluidic device of claim 6, wherein the at least partially conductive polymer material of the second sheet comprises an anisotropic conductivity layer.

8. The digital microfluidic device of claim 6, wherein the second sheet comprises a resistivity between about 10⁶ to about 10¹² Ohm-cm.

9. The digital microfluidic device of claim 8, wherein the polymer material of the second sheet is selected from a group including polypropylene, nylon, polystyrene, polycarbonate, and polyurethane.

10. The digital microfluidic device of claim 6, comprising:
a coating formed on an interior surface of the second sheet, the coating comprising at least one of:
a low contact angle hysteresis coating; and
a hydrophobic coating,
wherein the consumable microfluidic receptacle is to receive droplets which are polar.

11. The digital microfluidic device of claim 10, wherein the consumable microfluidic receptacle forms part of an assembly comprising the addressable charge depositing unit, wherein the addressable charge depositing unit comprises at least one of:
a first charge depositing element to emit charges having a first polarity and a second charge depositing element to emit charges having at least an opposite second polarity;
a grounded cylinder and a needle extending through the cylinder to generate, upon application of a first voltage to the needle, the airborne charges, wherein the first voltage is at least one order of magnitude greater than a target second voltage for the second sheet; or
a corona wire to generate the airborne charges and an addressable array of individually controllable electrode nozzles, spaced from the corona wire, to selectively permit passage of the airborne charges onto the exterior surface of the second sheet.

12. A method comprising:
receiving a microfluidic droplet between a first plate and a second plate of a replaceable microfluidic cavity;
positioning an addressable charge depositing unit to be in charging relation to, and spaced apart from, an exterior surface of the second plate; and selectively directing airborne charges from the addressable charging unit onto the second plate, to cause an electric field between the second plate and the first plate, to control electrowetting movement of the microfluidic droplet between the respective first and second plates.

13. The method of claim 12, comprising:
arranging the addressable charge depositing unit as a two dimensional array of individually controllable charging elements, the array having a size and a shape to cause the electrowetting movement of the droplet to any one target position of a corresponding array of target droplet positions of the replaceable microfluidic cavity.

14. The method of claim 12, wherein the positioning comprises:
moving the addressable charge depositing unit relative to the second plate while selective directing the airborne charges onto the second plate.

15. The method of claim 14, wherein the moving comprises:
causing, via the directing of airborne charges, a first voltage on the second plate at a first position of the addressable charge depositing unit relative to the second plate; and
causing, via the directing of airborne charges, a second voltage on the second plate at a second position of the addressable charge depositing unit relative to the second plate, the second voltage being substantially greater than the first voltage,
wherein the difference between the second voltage and the first voltage is to cause the electrowetting movement of the microfluidic droplet.
